(19) United States
(12) Patent Application Publication
(10) Pub. No.: US 2013/0182200 A1
(43) Pub. Date: Jul. 18, 2013

(54) LIGHT GUIDE PLATE, ILLUMINATION DEVICE, AND LIQUID CRYSTAL DISPLAY DEVICE

(71) Applicant: Takashi Ishizumi, Osaka-shi (JP)

(72) Inventor: Takashi Ishizumi, Osaka-shi (JP)

(73) Assignee: SHARP KABUSHIKI KAISHA, Osaka-shi, Osaka (JP)

(21) Appl. No.: 13/877,179

(22) PCT Filed: Oct. 3, 2011
(86) PCT No.: PCT/JP2011/072797

§ 371 Date: Apr. 1, 2013

(30) Foreign Application Priority Data
Oct. 8, 2010 (JP) 2010-228769

(51) Int. Cl. F21V 8/00

(52) U.S. Cl. CPC G02B 6/0036
USPC 349/65; 362/625; 362/626; 362/618

(57) ABSTRACT

A light guide plate (11) has: a light incidence surface (11c) through which light from a light source enters the light guide plate; a back surface (11b) for changing a direction of the light which has entered the light guide plate (11) through the light incidence surface (11c); and a light exit surface (11a). The back surface (11b) has a plurality of dot holes (12) each of which has an inclined surface for changing the direction of the light which has entered the light guide plate (11) through the light incidence surface (11a), and an angle θ between the inclined surface of each of the plurality of dot holes 12 and the back surface satisfies 53°≦θ≦56°.

### TECHNICAL FIELD

The present invention relates to a light guide plate, an illumination device, and a liquid crystal display device, each of which does not require an optical sheet having a light condensing function.

### BACKGROUND ART

One of illumination devices (so-called backlights) which have conventionally been used in liquid crystal display devices is an edge light type illumination device. The edge light type illumination device is constituted by (i) a light guide plate provided behind a liquid crystal display panel and (ii) a light source provided to a lateral side of the light guide plate. Light emitted from the light source is reflected in the light guide plate and indirectly illuminates the liquid crystal display panel in a uniform manner. This configuration realizes a thin illumination device.

However, in the edge light type illumination device, much of the light exits the light guide plate diagonally. That is, the light has a low directivity. Therefore, the illumination device has a low luminance. In view of the circumstances, there has been proposed a method for increasing the directivity of the light coming out of the light guide plate.

For example, Patent Literature 1 describes a method for increasing the directivity of light by use of a light guide plate as shown in FIG. 9. A light guide plate 20 shown in FIG. 9 is constituted by (i) a light guide 22 whose bottom surface has a plurality of protrusions 25 and (ii) a sheet 23 having a plurality of collimating lenses (convex lenses) 27 which constitute a light exit surface of the light guide plate 20.

The diameter D of each of the collimating lenses 27 is substantially the same as a distance L between adjacent ones of the protrusions 25. Furthermore, a line connecting the center of each of the collimating lenses 27 and the center of a corresponding one of the protrusions 25 is substantially parallel to an optical axis of the each of the collimating lenses 27.

The light guide plate 20 is configured such that light from a light source 21 zigzags within the light guide 22 while being totally reflected repeatedly, so as to be guided all over the light guide 22. Further, through a top surface of the light guide 22, light reflected at the protrusions 25 etc. exits diagonally. Such light is refracted by the collimating lenses and directed in one direction, whereby substantially collimated light travels from the light guide plate 20 to a liquid crystal panel (not illustrated).

### CITATION LIST

### Patent Literatures

Patent Literature 1

Japanese Patent Application Publication, Tokukai, No. 2008-198376 A (Publication Date: Aug. 28, 2008)

Patent Literature 2

Japanese Patent Application Publication, Tokukai, No. 2009-208092 A (Publication Date: Sep. 17, 2009)

Patent Literature 3

Japanese Patent Application Publication, Tokukai, No. 2010-134413 A (Publication Date: Jun. 17, 2010)

Patent Literature 4

Japanese Patent Application Publication, Tokukai, No. 2000-66029 A (Publication Date: Mar. 3, 2000)

Patent Literature 5

Japanese Patent Application Publication, Tokukai, No. 2006-55908 A (Publication Date: Mar. 2, 2006)

### SUMMARY OF INVENTION

### Technical Problem

However, light is emitted from the light source 21 at a wide range of angles. Therefore, according to the technique disclosed in Patent Literature 1, such light reflected at the protrusions 25 does not necessarily enter the corresponding collimating lenses 27. That is, light reflected at a certain protrusion 25 may not enter a corresponding collimating lens 27, but instead diagonally enter another collimating lens 27 next to the corresponding collimating lens 27. This causes light reflected at the certain protrusion 25 to enter the another collimating lens 27 at an angle other than a desirable angle, and such light may become stray light. Therefore, light that comes out of such a light guide does not necessarily have a high directivity.

Furthermore, a light guide that employs the collimating lenses 27 for the purpose of increasing the directivity of light is costly.

Next, the following explains an illumination device 8 shown in FIG. 10. The illumination device 8 includes a light source 81, a light guide plate 82, a diffuser (optical member) 83 and a prism sheet 84. The diffuser 83 is placed on a light exit surface of the light guide plate 82, and the prism sheet 84 is placed on the diffuser 83. The light guide plate 82 has, on its back surface facing the light exit surface, a plurality of ink parts 82b which are formed by application of ink by screen (plate) printing or ink-jet printing. Each of the ink parts 82b is curved so as to protrude outward from the back surface.

According to the illumination device 8 as shown in FIG. 10, part of light emitted from the light source 81 strikes, with an incident angle larger than a critical angle, the light exit surface of the light guide plate 82 and the back surface which is parallel to the light exit surface. The light which has struck the light exit surface or the back surface with an incident angle larger than the critical angle is totally reflected due to a difference between refractive indices of the light guide plate 82 and outside air, and propagates within the light guide plate 82.

Furthermore, part of the light emitted from the light source 81 or part of the light propagating within the light guide plate 82, which part has struck the ink parts 82b, is directed toward the light exit surface due to a catadioptric effect caused by a difference between refractive indices of the ink parts 82b and outside air. Note here that each of the ink parts 82b has a small curvature because of the surface tension of applied ink etc. Therefore, light reflected at the ink parts 82b travels diagonally relative to a direction of light propagation in the light guide plate 82.

The diffuser 83 has lenses thereon, which lenses are formed by application of many beads. The diffuser 83 can be a microlens sheet constituted by a large number of fine lenses, for example. The diffuser 83 has a scattering function, which shines the light from the light guide plate 82 in a uniform manner. The light which was made uniform by the diffuser 83 enters the prism sheet 84.

The prism sheet 84 is a sheet having a great light condensing property. The prism sheet 84 condenses light coming out of the diffuser 83 so that the light which exits the prism sheet 84 has a high directivity.

As described above, according to the light guide plate of a conventional technique, light exits diagonally through the light exit surface. Therefore, it is necessary to provide the prism sheet 84 which causes the light to have a directivity in a direction of a normal to the light exit surface.

As has been described, each of the foregoing light guide plates requires a collimating lens or a prism sheet which has a great light condensing property, in order to increase the directivity of light. This is a problem because the collimating lens and the prism sheet are costly.

The present invention has been made in view of the above problems, and an object of the present invention is to realize a light guide plate that has an increased light condensing property and thus does not require an optical sheet having a light condensing function.

### Solution to Problem

In order to attain the above object, a light guide plate in accordance with the present invention includes: a light incidence surface through which light from a light source enters the light guide plate; a back surface for changing a direction of the light which has entered the light guide plate through the light incidence surface; and a light exit surface (i) which faces the back surface and (ii) through which the light whose direction has been changed by the back surface exits, the back surface having a plurality of dot holes each of which has an inclined surface for changing the direction of the light which has entered the light guide plate through the light incidence surface, and an angle θ between the inclined surface of each of the plurality of dot holes and the back surface satisfying 53°≦θ≦56°.

According to the configuration, the direction of light which has traveled from the light incidence surface to the back surface is changed by the inclined surface, and the light exits in a direction close to a normal to the light exit surface. This makes it possible to form a light guide plate having a high directivity, without using a light condensing sheet having a great light condensing property such as a prism sheet.

An illumination device of the present invention preferably includes: the light guide plate; an optical sheet, having no light condensing function, placed so as to face the light exit surface of the light guide plate; and a light source provided at the light incidence surface.

According to the configuration, light emitted from the light source enters the light guide plate through the light incidence surface, its direction is changed by the inclined surface, and the light exits through the light exit surface. The light which has exited is given a desired optical effect(s) such as diffusion or polarized reflection by the optical sheet which does not have a light condensing property and is placed on the light exit surface, and thereafter exits from the illumination device. This makes it possible to provide an illumination device which utilizes light that is caused by the light guide plate to exit through the light exit surface in a direction close to a normal to the light exit surface.

Accordingly, it is possible to form an inexpensive illumination device which emits light having a high directivity and thus does not require a light condensing sheet which has been required in conventional techniques.

A liquid crystal display device of the present invention preferably includes: the illumination device; and a liquid crystal display panel which receives light from the illumination device serving as a light source.

This makes it possible to form an inexpensive liquid crystal display device which emits light having a high directivity.

### Advantageous Effects of Invention

As has been described, a light guide plate of the present invention includes: a light incidence surface through which light from a light source enters the light guide plate; a back surface for changing a direction of the light which has entered the light guide plate through the light incidence surface; and a light exit surface (i) which faces the back surface and (ii) through which the light whose direction has been changed by the back surface exits, the back surface having a plurality of dot holes each of which has an inclined surface for changing the direction of the light which has entered the light guide plate through the light incidence surface, and an angle θ between the inclined surface of each of the plurality of dot holes and the back surface satisfying 53°≦θ≦56°.

This makes it possible to form a light guide plate having a high directivity, without using a light condensing sheet having a great light condensing property such as a prism sheet.

### BRIEF DESCRIPTION OF DRAWINGS

FIG. 1 is a cross-sectional view illustrating a configuration of a light guide plate in accordance with one embodiment of the present invention.

FIG. 2 is a cross-sectional view illustrating a configuration of a backlight in accordance with one embodiment of the present invention.

FIG. 3 is a cross-sectional view illustrating a configuration of a liquid crystal display device in accordance with one embodiment of the present invention.

FIG. 4 is a view illustrating directivity and intensity of light that has been reflected at inclined surfaces of dot holes in a back surface of the light guide plate and has exited through the light exit surface.

FIG. 5 is a view illustrating directivity and intensity of light that has exited through a light exit surface of a light guide plate of a comparative example, which light guide plate has ink applied on its back surface.

FIG. 6 is a cross-sectional view of a dot hole in the light guide plate shown in FIG. 1.

FIG. 7 is a view illustrating directivity and intensity of light that has been reflected at inclined surfaces of dot holes and exited through the light exit surface, obtained when the length of a base of each dot hole, height of the dot hole, and an angle between an inclined surface and the base of the dot hole are varied.

FIG. 8 is a graph showing the latitude of light exited through the light exit surface, against the angle between the inclined surface and the base.

FIG. 9 is a view schematically illustrating an inner structure of a conventional backlight.

FIG. 10 is a view, for explanation of an object, which schematically illustrates an inner structure of another backlight.

### DESCRIPTION OF EMBODIMENTS

The following description will discuss an embodiment of the present invention with reference to the drawings. It should be noted that, unless otherwise specified, the present invention is not limited to the embodiment, and sizes, materials, shapes, and relative positions of constituents described in the present embodiment are not intended to limit the scope of the present invention but mere examples for explanation.

(Overall Configuration of Liquid Crystal Display Device)

A liquid crystal display device 10 of the present invention includes (i) a liquid crystal display panel 15 having a display screen for displaying images, (ii) a backlight (illumination device) 1 provided on a back surface (a surface opposite to the display surface) side of the liquid crystal display panel 15, and (iii) a frame (not illustrated) in which the liquid crystal display panel 15 and the backlight 1 are stored (see FIG. 3). The liquid crystal display panel 15 used here can be a known liquid crystal display panel in which a plurality of pixels for displaying images are arranged.

The backlight 1 includes a light guide plate 11, a diffuser (optical sheet) 13 which has no light condensing properties, and a light source 14.

Note that a driving circuit (not illustrated) for driving the light source 14 is separately provided. Furthermore, it is preferable to provide, on the back surface side of the light guide plate 11, a reflecting sheet (not illustrated) for reuse of light (stray light) leaked out of the light guide plate 11.

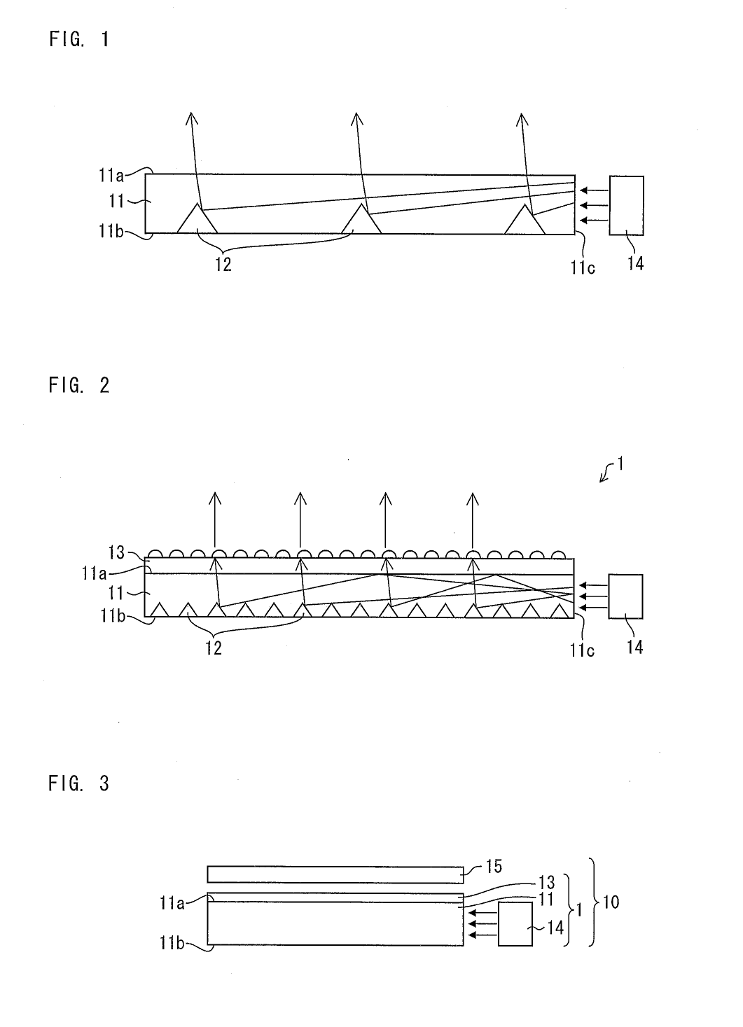

The light guide plate 11 has (i) a light incidence surface 11c (see FIGS. 1 and 2) through which light from the light source 14 enters the light guide plate 11, (ii) a back surface 11b which changes a direction of the light which has entered through the light incidence surface 11c, and (iii) a light exit surface 11a which faces the back surface 11b and through which the light whose direction has been changed by the back surface 11b exits.

The light exit surface 11a is a surface above which the liquid crystal panel 15 is provided. Furthermore, since the backlight 1 of the present invention is of an edge light type, the light incidence surface 11c corresponds to one side surface of a rectangular plate whose bottom surface and top surface are the back surface 11b and the light incidence surface 11c, respectively.

The light guide plate 11 is made of acrylic resin (e.g., polymethylmethacrylate; PMMA) or transparent resin material such as polycarbonate (PC). The thickness of the light guide plate 11 is approximately 1 mm to 4 mm, for example. Further, the refractive index of the light guide plate 11 is approximately 1.45 to 1.60, for example.

When light exits from the light guide plate 11 which has a higher refractive index to air which has a lower refractive index (1.00), the light spreads to a greater extent if the transparent resin material has a higher refractive index. Therefore, the transparent resin material for the light guide plate 11 is preferably a resin material having a low refractive index. Acrylic resin has a refractive index of 1.49, which is lower than that (1.59) of polycarbonate, and is less expensive than polycarbonate. Therefore, the light guide plate 11 of the present embodiment is made of acrylic resin.

It should be noted that the material for the light guide plate 11 is not limited to acrylic resin, and can be for example polycarbonate. Acrylic resin and polycarbonate are highly transparent and weatherproof, and thus are each suitably usable as a transparent material for the light guide plate 11.

The light source 14 used here can be (i) a white LED (light emitting diode) light source, (ii) an RGB-LED (light-emitting diode obtained by molding R, G and B chips into respective packages) light source, (iii) a multicolor LED light source, (iv) a laser light source or (v) a CCFL (cathode fluorescent tube).

(Details of Backlight 1)

The following description discusses details of the backlight 1 of the present invention. FIG. 2 is a cross-sectional view illustrating a configuration of the backlight 1 of the present invention.

As illustrated in FIG. 2, the backlight 1 includes (i) a light guide plate 11, (ii) a diffuser (optical sheet) 13 placed so as to face the light exit surface 11a of the light guide plate 11 and (iii) a light source 14 provided so as to face the light incidence surface 11c. Light emitted from the light source 14 and entered the light guide plate 11 through the light incidence surface 11c is guided within the light guide plate 11 and exits the light guide plate 11 through the light exit surface 11a. The liquid crystal display panel 15 is irradiated with this light.

Furthermore, as illustrated in FIG. 2, the back surface 11b of the light guide plate 11 has a plurality of dot holes 12 each having an inclined surface for changing a direction of the light which has entered the light guide plate 11 through the light incidence surface 11c. Through the light exit surface 11a, the light whose direction has been changed by the back surface 11b exits the light guide panel 11.

Each of the dot holes 12 is a recess locally made in the back surface 11b, and has a shape of a cone or a quadrangular pyramid. Each of the dot holes 12 is a recess locally made so as to protrude inside the light guide plate 11 from the back surface 11b, and can have a shape of a cone that ends in a perfect circle or a regular polygonal pyramid. The shape of a cone that ends in a perfect circle or a regular polygonal pyramid makes it possible to achieve isotropic light reflecting properties.

The dot holes 12 can be made by use of a laser beam described in Patent Literature 3. With use of a laser beam, it is possible to easily make fine dot holes 12 each having a diameter of about 100 microns. The diameter of 100 microns means that the diameter of a base of a cone or the diameter of a circle circumscribing a base of a polygonal pyramid is 100 microns. Furthermore, the angle of inclination of the inclined surface of each of the dot holes 12 can be controlled with use of a laser beam by a laser processing method using a galvanic mirror (see Patent Literature 2). By a laser processing method using a galvanic mirror, it is possible to easily control the angle of inclination of the inclined surface of each of the dot holes 12.

It should be noted that the dot holes 12 can be made not only by a laser processing, but also by, for example, a process using a mold for a light guide plate (see Patent Literature 4).

(Control of Light by Dot Holes 12)

The following description discusses, with reference to FIGS. 1, 4 and 5, an example of how light is controlled at the dot holes 12 of the present invention.

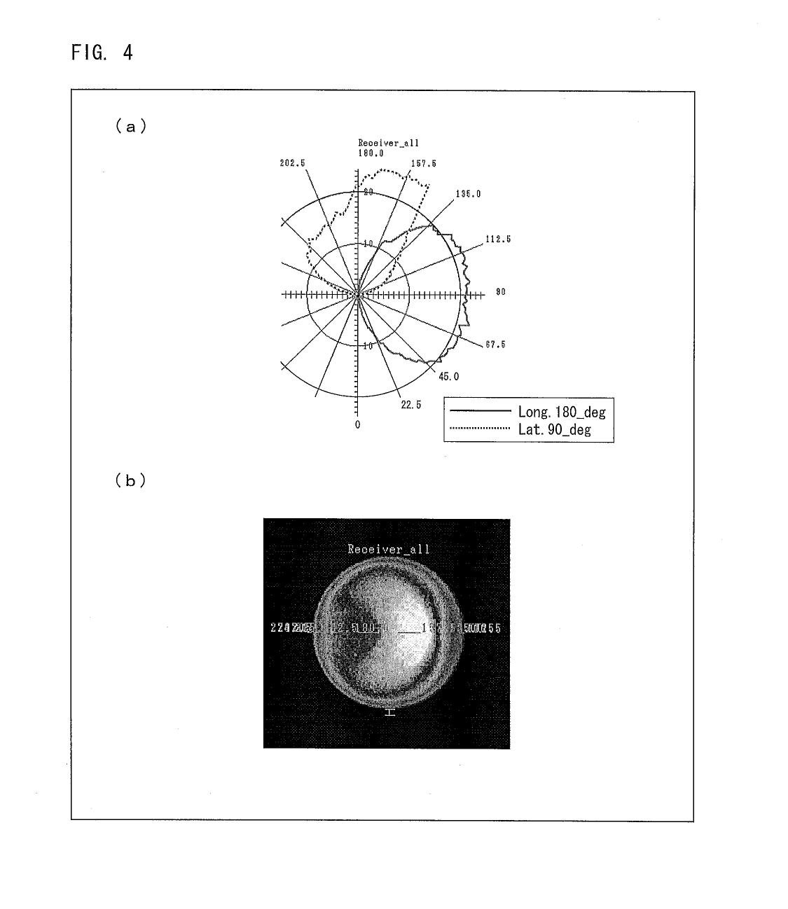

As illustrated in FIG. 1, a direction of light which has entered the light guide plate through the light incidence surface 11c is changed at inclined surfaces of the dot holes 12, and the light exits the light guide plate 11 through the light exit surface 11a. FIG. 4 illustrates the directivity of light obtained in a case where such a light guide plate 11 is used.

(a) of FIG. 4 is a graph showing directivity of light reflected at the inclined surfaces of the dot holes 12 and exited through the light exit surface 11a. In (a) of FIG. 4, intensity distribution of light in latitude, which light has exited through the light exit surface 11a, is indicated by a dotted line, and, intensity distribution of the light in longitude is indicated by a solid line. It should be noted that, assuming that a point light source is located at the center of a sphere, a latitude and a longitude indicate a position on the surface of the sphere through which position a light beam exits the sphere. In a case where the position on the surface through which position the light beam exits the sphere is shown in polar coordinates, the latitude corresponds to a polar angle and the longitude corresponds to an azimuth angle.

The directivity of the light with respect to latitude is as follows. That is, it is shown that, assuming that a horizontal line passing through the center of the graph shown in (a) of FIG. 4 is the equator and a portion above the equator is an arctic area, the light indicated by a dotted line in (a) of FIG. 4 travels diagonally to the back in a direction of approximately 70 degrees north latitude.

The directivity of the light with respect to longitude is as follows. That is, it is shown that, assuming that (i) the earth is seen from the Arctic and (ii) the lowermost part of the circle shown in (a) of FIG. 4 is 0 degrees longitude and the longitude increases counterclockwise, the intensity distribution of the light indicated by a solid line in (b) of FIG. 4 is spreading across an area from about 22.5 degrees longitude to about 157.5 degrees longitude.

(b) of FIG. 4 shows the intensity distribution of the light obtained when the light guide plate 11 in the state of (a) of FIG. 4 is seen from above. The whiter portion indicates that intensity is stronger. As is clear from (b) of FIG. 4, the center of the intensity of the light is close to a central portion.

Note, here, that a light condensing sheet provided to a conventional light guide plate reduces the spreading of light as below. That is, for example in a case where light which has exited the light guide plate 11 through the light exit surface 11a is spreading at an angle of approximately 40°, the light condensing sheet reduces the angle to approximately 25°. As such, the light condensing sheet brings about a light condensing effect, i.e., an effect of increasing, by approximately 20% to 30%, luminance (luminance as seen vertically from front, hereinafter referred to as front luminance) observed when the light guide plate 11 is seen from above.

On the other hand, according to the present invention, the light which has exited the light guide plate 11 travels diagonally to the back in a direction of approximately 70 degrees north latitude (see (a) of FIG. 4). That is, the light exits at approximately 20°. This shows that it is possible to reduce the spreading of light as compared to a case where the light condensing sheet is used. This makes it possible to obtain a front luminance equivalent to or greater than that obtained in a case where the light condensing sheet is used. Accordingly, it is possible to eliminate the need for the light condensing sheet.

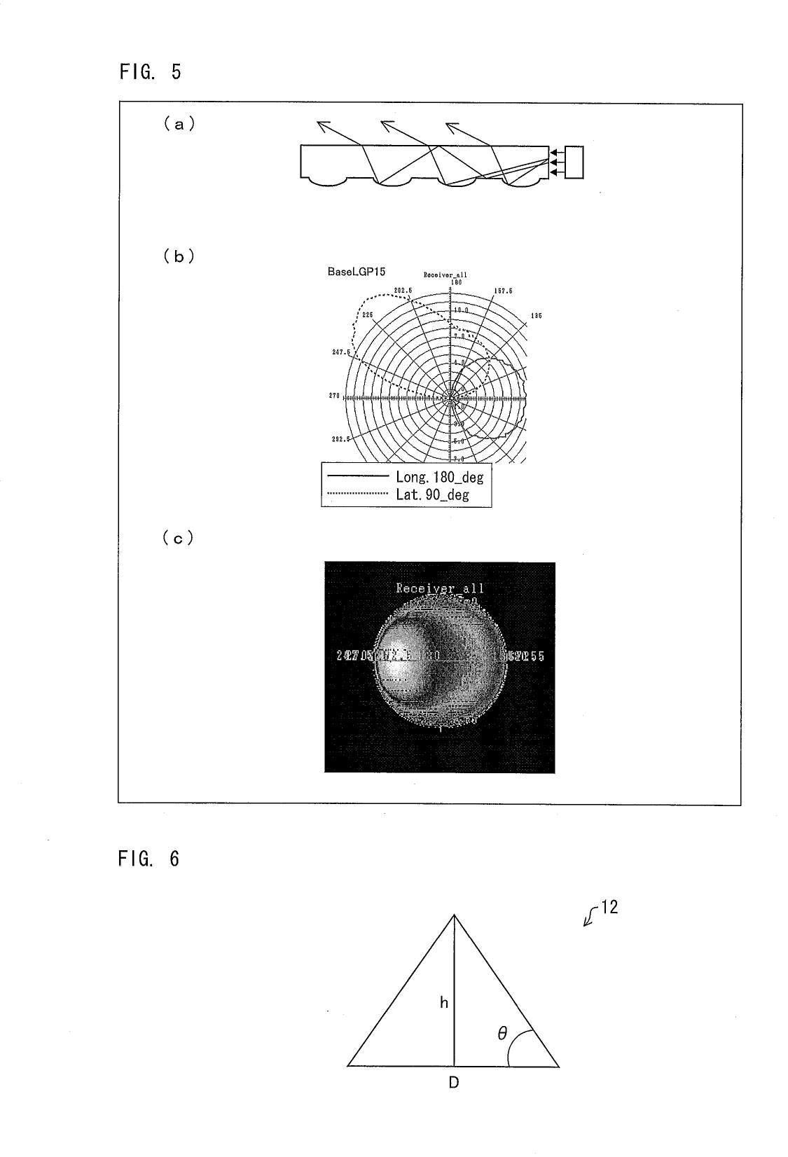

(a) of FIG. 5 is a cross-sectional view of a light guide plate in which ink is applied to a back surface 11b by screen (plate) printing or ink-jet printing instead of the dot holes 12. (b) of FIG. 5 is a graph showing directivity of light which has exited through a light exit surface, observed when the light guide plate shown in (a) of FIG. 5 is used. As shown in (b) of FIG. 5, spreading of light (indicated by a solid line) in longitude is not so different from that shown in (b) of FIG. 4; however, light indicated by a dotted line travels diagonally to the front in a direction of approximately 45 degrees north latitude.

(c) of FIG. 5 shows intensity distribution of light, obtained when the light guide plate shown in (a) of FIG. 5 and in the state of (b) of FIG. 5 is seen from above. It is clear from (c) of FIG. 5 that the center of the intensity of the light is deviated to the left.

In principle, light passing through the light guide plate is totally reflected and guided due to a difference between refractive indices of material constituting the light guide plate and of outside air. However, in a case where a light guide plate in which ink is applied to the back surface is used as shown in FIG. 5, a change occurs in a reflection angle at an interface between air and the light guide plate. Accordingly, the light is not totally reflected at a surface facing the back surface, and exits the light guide plate. The ink applied to the back surface of the light guide has a shape of a thin, convex spherical surface having a large curvature. Therefore, the light guided through the light guide plate exits at angles as shown in (b) of FIG. 5.

As has been described, it is shown that, according to the light guide plate 11 whose back surface 11b has the dot holes 12 (see FIG. 1), the light which has entered the light guide plate 11 exits in a direction closer to a normal to the light exit surface, as compared to the light guide plate in which ink is applied to the back surface (see (a) of FIG. 5).

(Angle of Inclination of Dot Hole 12)

The following description discusses, with reference to FIGS. 6 to 8, an angle of inclination (cone angle) of an inclined surface of each of the dot holes 12. FIG. 6 is a cross-sectional view of a dot hole 12. The dot hole 12 is made in the back surface 11b of the light guide plate 11 so as to protrude inside the light guide plate 11. As shown in FIG. 6, the dot hole 12 has a triangular section whose base has a length of D, whose height is h and whose angle between the inclined surface and the base is θ.

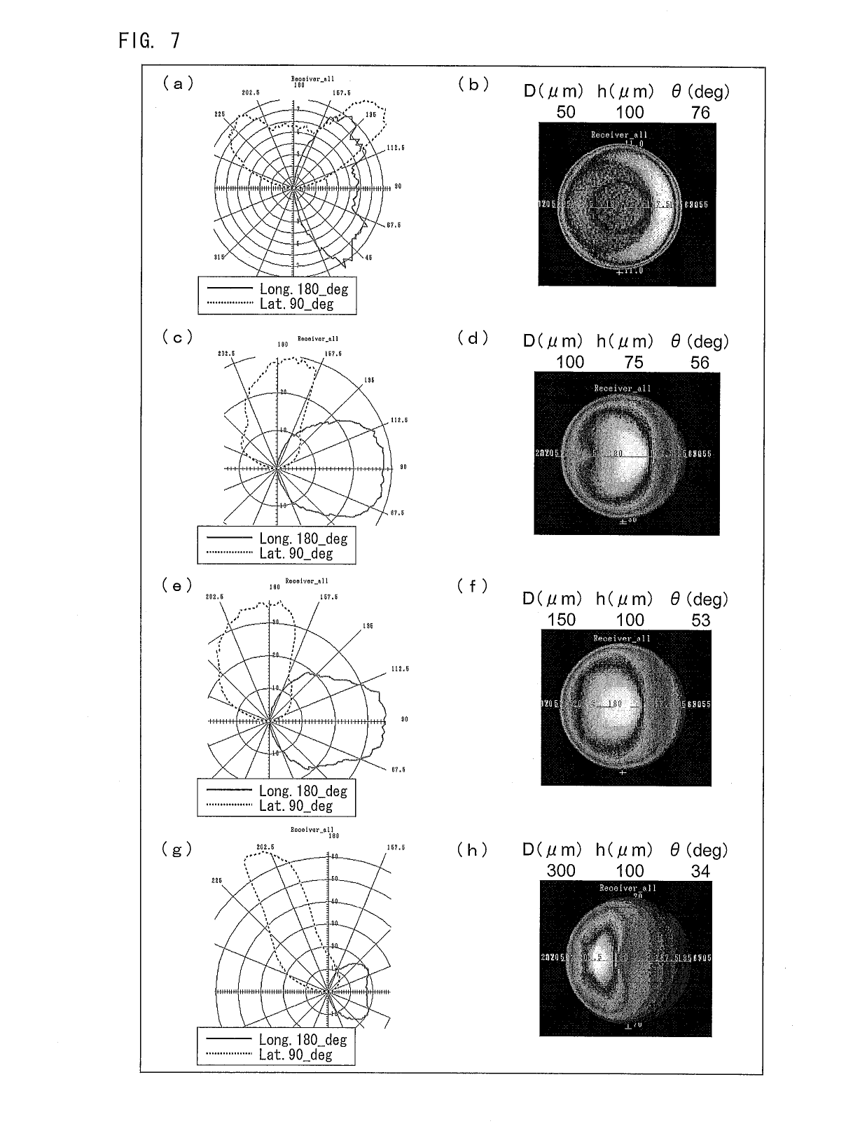

FIG. 7 shows directivity and intensity distribution of light reflected at an inclination surface of a dot hole 12 and exited through the light exit surface 11a, obtained when the length D of the base, the height h, and the angle θ between the inclined surface and the base of the dot hole 12 are varied.

(a) of FIG. 7 is a graph showing directivity obtained in a case where D=50 μm, h=100 μm and θ=76°. (b) of FIG. 7 shows intensity distribution of light obtained when the light guide plate 11 in the state of (a) of FIG. 7 is seen from above.

Similarly, (c) and (d) of FIG. 7, respectively, are a graph showing directivity of light and a view showing intensity distribution of the light obtained in a case where D=100 μm, h=75 μm and θ=56°, (e) and (f) of FIG. 7, respectively, are a graph showing directivity of light and a view showing intensity distribution of the light obtained in a case where D=150 μm, h=100 μm and θ=53°, and (g) and (h) of FIG. 7, respectively, are a graph showing directivity of light and a view showing intensity distribution of the light obtained in a case where D=300 μm, h=100 μm and θ=34°.

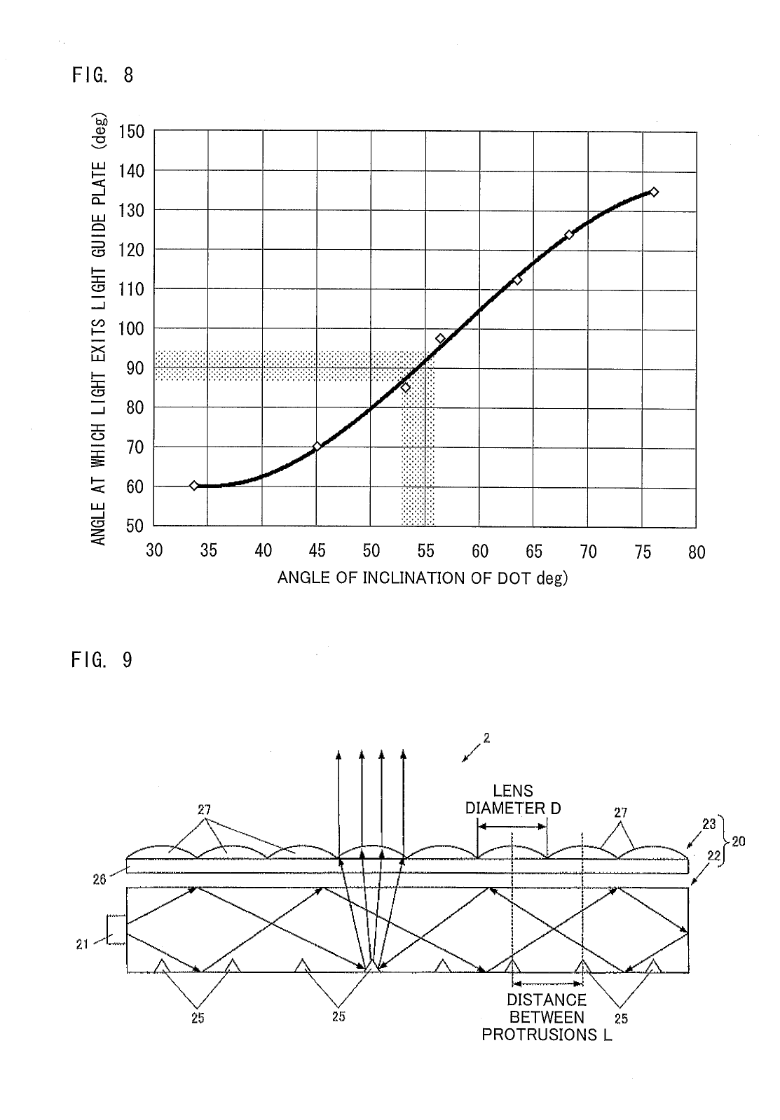

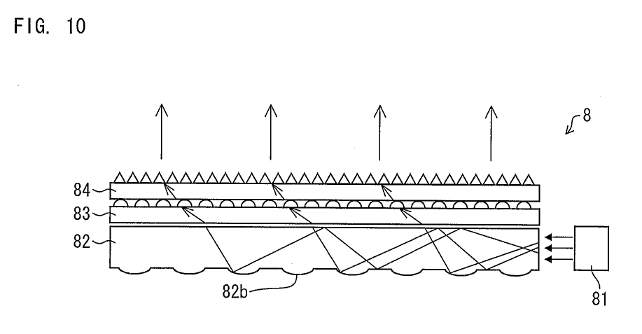

FIG. 8 is a graph showing the latitude of light exited through the light exit surface 11a, against the angle θ between the inclined surface and the base. In FIG. 8, taken along the vertical axis are values obtained by converting directions of light indicated by dotted lines in the graphs of (a), (c), (e) and (g) of FIG. 7 into values each representing an angle between the light exit surface 11a of the light guide plate 11 and light which has exited through the light exit surface 11a. That is, the values on the vertical axis in FIG. 8 are, assuming that the light exit surface 11a of the light guide plate 11 extends along the direction of 270 degrees in the graphs, values of angles each of which is between the light exit surface 11a and light which has exited through the light exit surface 11a.

For example, in a case of (g) of FIG. 7, the direction of light indicated by a dotted line indicates a value of approximately 210 degrees. Assuming that the direction of 270 degrees in the graph is 0 degrees, an angle between the light exit surface 11a of the light guide plate 11 and the light which has exited is approximately 60°. FIG. 8 is a graph in which such values are plotted.

As is clear from FIG. 8, in a case where the angle θ between the inclined surface and the base satisfies 53°≦θ≦56°, light exits through the light exit surface 11a at approximately 90°. That is, in a case where the angle θ between the inclined surface and the base satisfies 53°≦θ≦56°, a direction of light which has traveled from the light incidence surface 11c to the back surface 11b is changed at the inclined surface, and the light exits in a direction close to a normal to the light exit surface 11a. This makes it possible to form a light guide plate having a high directivity, without using a light condensing sheet having a great light condensing function such as a prism sheet.

As has been described, a light guide plate 11 in accordance with an embodiment of the present invention is a light guide plate having: a light incidence surface 11c through which light from a light source 14 enters the light guide plate 11; a back surface 11b for changing a direction of the light which has entered the light guide plate 11 through the light incidence surface 11c; and a light exit surface 11a (i) which faces the back surface 11b and (ii) through which the light whose direction has been changed by the back surface 11b exits. The back surface 11b has a plurality of dot holes 12 each of which has an inclined surface for changing the direction of the light which has entered the light guide plate 11 through the light incidence surface 11a, and an angle θ between the inclined surface of each of the plurality of dot holes 12 and the back surface satisfies 53°≦θ≦56°.

This makes it possible to increase light condensing properties, and thus possible to realize a light guide plate that does not require any optical sheet having a light condensing function.

Further, the light incidence surface 11c corresponds to a side surface of a rectangular plate whose bottom surface and whose top surface are the back surface 11b and the light exit surface 11a, respectively.

The light guide plate 11 having the above configuration is particularly suitable for an edge light type illumination device. Specifically, according to such a light guide plate 11, the inclined surface causes light, which enters the light guide plate 11 through one side surface of the light guide plate 11 having a shape of a rectangular plate, to travel in a direction of a normal to the back surface 11b or in a direction close to the normal to the back surface 11b.

Further, it is preferable that each of the plurality of dot holes 12 is (i) a recess which is made locally so as to protrude inside the light guide plate 11 from the back surface 11b and (ii) has a shape of a cone or a polygonal pyramid.

This makes it possible to easily make a plurality of dot holes 12 by for example processing the back surface 11b of the light guide plate 11 by use of a laser beam from outside the light guide plate 11. Furthermore, the shape of a cone or a polygonal pyramid is advantageous to cause light beams, which come from various directions to the surfaces of the cone or the polygonal pyramid, to travel in the direction of the normal to the light exit surface 11a.

The present invention is not limited to the embodiments, but may be altered within the scope of the claims. That is, an embodiment derived from a proper combination of technical means altered within the scope of the claims is encompassed in the technical scope of the invention.

### INDUSTRIAL APPLICABILITY

The present invention is applicable to a light guide, an illumination device including the light guide, and a liquid crystal display device.

### REFERENCE SIGNS LIST

1 Backlight (illumination device)
10 Liquid crystal display device
11 Light guide plate
11a Light exit surface
11b Back surface
11c Light incidence surface
12 Dot hole
13 Diffuser (optical sheet)
14 Light source
15 Liquid crystal display panel

1. A light guide plate, comprising:
a light incidence surface through which light from a light source enters the light guide plate;
a back surface for changing a direction of the light which has entered the light guide plate through the light incidence surface; and
a light exit surface (i) which faces the back surface and (ii) through which the light whose direction has been changed by the back surface exits,
the back surface having a plurality of dot holes each of which has an inclined surface for changing the direction of the light which has entered the light guide plate through the light incidence surface, and
an angle θ between the inclined surface of each of the plurality of dot holes and the back surface satisfying 53°≦θ≦56°.

2. The light guide plate according to claim 1, wherein the light incidence surface corresponds to a side surface of a rectangular plate whose bottom surface and whose top surface are the back surface and the light exit surface, respectively.

3. The light guide plate according to claim 1, wherein each of the plurality of dot holes is (i) a recess which is made locally so as to protrude inside the light guide plate from the back surface and (ii) has a shape of a cone or a polygonal pyramid.

4. An illumination device, comprising:
a light guide plate recited in claim 1;
an optical sheet placed so as to face the light exit surface of the light guide plate; and
a light source provided at the light incidence surface.

5. A liquid crystal display device, comprising:
an illumination device recited in claim 4; and
a liquid crystal display panel which receives light from the illumination device serving as a light source.
